(19) United States
(12) Patent Application Publication
(10) Pub. No.: US 2007/0102903 A1
(43) Pub. Date: May 10, 2007

(54) Airbag door structure for vehicular passenger seat

(75) Inventor: Byung Seok Kong, Gyeonggi-do (KR)

Correspondence Address: EDWARDS & ANGELL, LLP, P.O. BOX 55874, BOSTON, MA, 02205, US

(73) Assignee: Hyundai Motor Company, Seoul (KR)

(21) Appl. No.: 11/301,698

(22) Filed: Dec. 12, 2005

(30) Foreign Application Priority Data
Nov. 8, 2005 (KR) 2005-0106388

(51) Int. Cl. B60R 21/215; B60R 21/045

(52) U.S. Cl. 280/728.3; 280/752

(57) ABSTRACT

Disclosed is an airbag door structure for vehicular passenger seats having an airbag door and a crash pad integrally formed, preferably in a dual injection molding process using different materials to hide tear lines of the airbag door and crash pad for aesthetic appearance. The airbag door structure can have a reduced number of components to decrease weight and save cost and uses a material undergoing sever change in physical properties as temperature varies for the crash pad and a ductile material undergoing little change as temperature varies for the airbag door so that the airbag can expand stably at various external temperatures without being easily tom off by impact from outside the door.

The present invention claims priority from Korean patent application no. 2005-0106388 filed Nov. 11, 2005, which is incorporated by reference herein in its entirety.

### BACKGROUND OF THE INVENTION

1. Field of the Invention

The present invention relates to an airbag door structure for vehicular passenger seats, and more particularly to an airbag door structure for vehicular passenger seats having an airbag door and a crash pad integrally formed in a dual injection molding process using different materials to reduce cost and weight and provide an airbag having excellent expansion performance, strong resistance to external impact, and improved quality.

2. Background

In general, airbags are positioned in front of driver and passenger seats to protect occupants in the case of accidents.

Airbags for passenger seats are normally positioned on the top of a glove box beneath an instrument panel.

Conventional airbags for passenger seats are usually seamless airbags, which are operated as follows: when the airbags begin to expand, pressure acts on a door plate, and tear lines around a door cover are tom off by laser scoring so that the airbags can expand.

The door plate is made of stainless steel between 0.8 t-1.2 t. The door cover and the tear lines are made of the same plastic as the crash pad.

More particularly, when an airbag 1 begins to expand, as shown in FIG. 1, a door plate 2 and a door cover 4, which is attached to the door plate 2, rotate about a fixed point 5 on top of the door plate 2. A hinge unit 6, which is made of stainless steel, is sufficiently unfolded so that the door plate 2 can rotate without interference.

The door plate 2 must be designed in such a manner that, when the airbag 1 expands, pressure is uniformly distributed over the front surface of the door plate 2. In addition, the door plate 2 is provided with a traverse groove 7 or has at least a predetermined thickness so that the door plate 2 has enough traverse rigidity to avoid bending in the traverse direction. Otherwise, the airbag 1 fails to expand as desired.

It is to be noted that, when the airbag expands, no fragment is allowed to be generated by opening of the door. If the hinge unit 6 is short or thick and fails to expand sufficiently when the door plate 2 rotates, an end of the cover 4 attached to the door plate 2 inevitably folds, as shown in part a of FIG. 1.

If the folded part is subjected to a low-temperature expansion test at a temperature of −35° C. (regulation temperature), it may fracture due to increase in brittleness and generate fragments. Particularly, the hinge unit 6 may fracture as shown in part d of FIG. 2.

There are a number of methods for preventing the hinge unit 6 from fracturing. However, all of the methods are substantially limited by the exterior of the crash pad and the layout of the airbag module.

According to a method for avoiding such fracture, for example, the hinge unit 6 is lengthened so that the door plate 2 can rotate without interference. To this end, the angle b or length c of the groove 7 must be decreased or increased. However, such decrease or increase can only be made when shaping the door plate 2 using press molds. Particularly, the overall contour is substantially restricted, because interference with adjacent components must be avoided.

In addition, the fragments generated from the folded part of the cover due to collision of vehicles may injure occupants.

The information set forth in this Background of the Invention section is only for enhancement of understanding of the invention and should not be taken as an acknowledgement or any form of suggestion that this information forms the prior art that is already known to a person skilled in the art.

### SUMMARY OF THE INVENTION

Accordingly, the present invention has been made to solve the above-mentioned problems occurring in the prior art, and an object of the present invention is to provide an airbag door structure for vehicular passenger seats which has an airbag door and a crash pad integrally formed in a dual injection molding process using different materials to hide tear lines of the airbag door and crash pad for aesthetic appearance, which has a reduced number of components to decrease weight and save cost, and which uses a material undergoing sever change in physical properties as temperature varies for the crash pad and a ductile material undergoing little change as temperature varies for the airbag door so that the airbag can expand stably at various external temperatures without being easily tom off by impact from outside the door.

In order to accomplish this object, there is provided an airbag door structure for vehicular passenger seats including a housing for containing an airbag in a cavity having an open top, a crash pad coupled to an instrument panel, and an airbag door coupled to the crash pad while covering the housing, wherein the crash pad and the airbag door are integrally formed in a dual injection molding process using different materials.

According to an embodiment of the present invention, the crush pad is made of PPF.

According to an embodiment of the present invention, the airbag door is made of a material having higher ductility than the crash pad.

According to an embodiment of the present invention, the airbag door is made of TPO or TPE.

According to an embodiment of the present invention, the airbag door has tear lines formed on a lower surface thereof as V-grooves.

According to an embodiment of the present invention, the V-grooves of the airbag door are simultaneously formed in the dual injection molding process.

According to an embodiment of the present invention, a contact portion is formed in the shape of a step when the crash pad and the airbag door are injected.

The invention also includes vehicles that comprise one or more airbag door structures as described herein.

It is understood that the term “vehicle” or “vehicular” or other similar terms as used herein is inclusive of motor vehicles in general such as passenger automobiles including sports utility vehicles (SUV), buses, trucks, various commercial vehicles, and the like.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view briefly showing an airbag door structure for vehicular passenger seats according to the prior art;

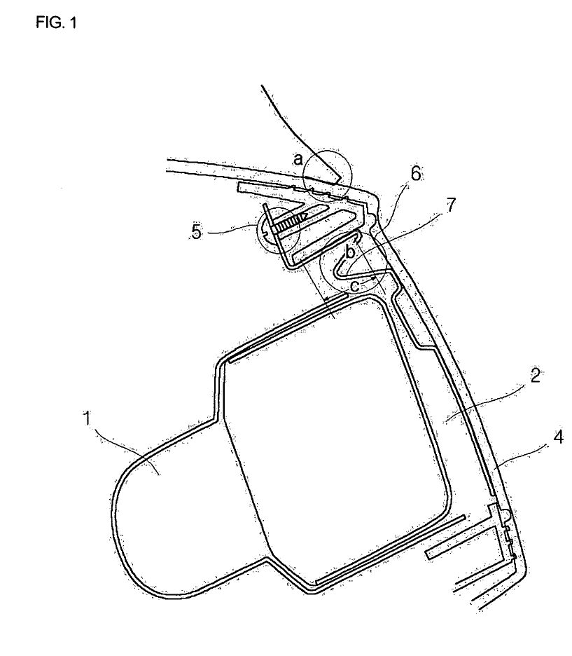

FIG. 2 shows an airbag door structure for vehicular passenger seats according to the prior art, which is in service; and

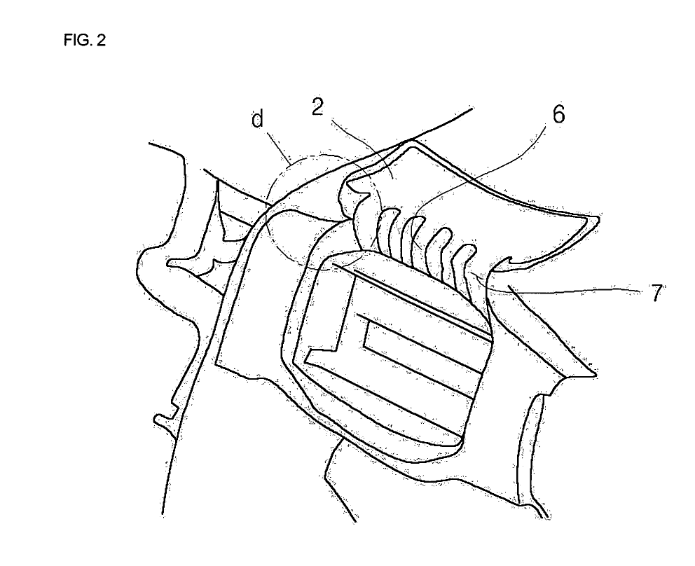

FIG. 3 is a perspective view showing an airbag door structure for vehicular passenger seats according to the present invention.

### DETAILED DESCRIPTION OF THE PREFERRED EMBODIMENTS

As discussed above, an airbag door structure for a vehicular passenger seat is provided which suitably comprises a housing for containing an airbag, a crash pad coupled to an instrument panel, and an airbag door coupled to the crash pad, wherein the crash pad and the airbag door are suitably formed in an injection molding process, preferably using different materials. Preferably, the crash pad and the airbag door are integrally formed in a dual injection molding process, preferably using different materials.

Hereinafter, a preferred embodiment of the present invention will be described with reference to the accompanying drawings. In the following description and drawings, the same reference numerals are used to designate the same or similar components, and so repetition of the description on the same or similar components will be omitted.

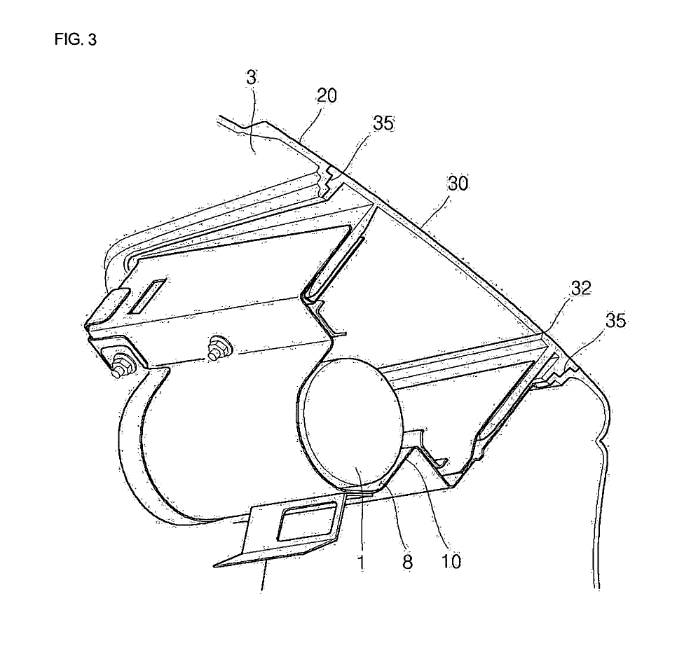

FIG. 3 is a perspective view showing an airbag door structure for vehicular passenger seats according to the present invention.

As shown in the drawing, an airbag door structure for vehicular passenger seats according to the present invention includes a housing 10 for containing an airbag 1 in a cavity 8 having an open top, a crash pad 20 coupled to an instrument panel 3, and an airbag door 30 coupled to the crash pad 20 while covering the housing 10.

The passenger seat airbag 1 is an auxiliary device of a seat belt and acts as a safety device for protecting an occupant.

The airbag 1 is adapted to expand when impact is generated in front of a vehicle and impact energy reaches a predetermined level. As a result, impact transmitted to an occupant is alleviated.

The airbag 1 is generally a disk-shaped bag made of nylon fibers. It has a capacity of about 50-60 t and is positioned in the cavity 8 of the housing 10.

The housing 10 is covered with the airbag door 30, which is integral with the crash pad 20 coupled to the instrument panel 3.

The crash pad 20 and the airbag door 30 are made of different materials. Particularly, the crash pad 20 is preferably made of or comprises a phenolic polymer such as a phenolic copolymer e.g. a novolac or more preferably PPF (i.e., a phenol-furfural polymer, where furfural may be suitably represented as 2-CH-furan) having strong rigidity, and the airbag door 30 is made of or comprises TPO (i.e. a thermoplastic olefin) and/or TPE (i.e. thermoplastic elastomer) having ductility higher than that of the crash pad 20. Exemplary TPO (thermoplastic olefin) include low density polyethylene and linear low density polyethylene, among others. Exemplary TPE include a wide variety of polymers. Hylene (DuPont) thermoplastic elastomers are commercially available.

The reason the airbag door 30 is made of or comprises TPO (thermoplastic olefin) or TPE (i.e. thermoplastic elastomer) is that they undergo little change in physical properties as temperature varies and can uniformly maintain the expansion performance of the airbag 1 over a wide range of temperatures.

The crash pad 20 and the airbag door 30 are integrally formed using different materials in a dual injection molding process. Particularly, one of the crash pad 20 and airbag door 30 is first injected, and the other is injected while being coupled to the former.

As a result, a separate steel hinge plate and chute structure is unnecessary, which has been used to couple the crash pad and the airbag door according to the prior art.

When the crash pad 20 and the airbag door 30 are molded by dual injection, a contact portion 35 is formed as an integral injection section in the shape of a step.

The step-shaped contact portion 35 increase coupling strength at the injection interface and avoids sectional shear tear when the airbag 1 expands.

The airbag door 30 has tear lines 32 formed on both sides of its lower surface as V-grooves having the shape of tear seams.

The V-grooves of the airbag door 30 are simultaneously formed during dual injection molding.

As a result, a laser scoring process is unnecessary, which has been separately used to process tear lines 32 according to the prior art. This reduces manufacturing cost.

Since the tear lines 32 are formed on the lower surface of the airbag door 30 during integral injection, they are hidden without being exposed to the exterior. This provides aesthetic appearance.

Alternatively, the tear lines 32 may have H-shape or V-shape.

Since the preferred TPO used for the airbag door 30 has high strength against impact, no edge is generated in the shape of a cutting edge, even when external impact acts on the vehicle and the tear lines 32 fracture, in contrast to conventional invisible hard type airbag doors.

The operation of the airbag door structure for vehicular passenger seats according to an embodiment of the present invention, constructed as above, will now be described.

When a vehicle collides, a sensor detects the collision. When the amount of impact energy created by the impact reaches a predetermined level, a triggering device explodes actuation gas. The exploded gas causes an internal airbag module to expand the airbag 1 instantly.

As the airbag 1 is expanded and unfolded, the resulting impulse fractures the tear lined 32 on the lower surface of the airbag door 30 and prevent an occupant from leaning forwards suddenly. This avoids injury.

Since the contact portion 35 between the crash pad 20 and the airbag door 30 is formed by dual injection molding and has high bonding strength, no shear tear occurs to bonded sections even when the airbag 1 expands.

Therefore, in contrast to the prior art, the hinge unit of the cover of the airbag door structure does not fracture. This means that no fragment is generated and injures occupants.

The airbag door structure for vehicular passenger seats according to the present invention is advantageous as follows:

Firstly, no shear tear occurs to coupled sections, even when the airbag expands, and no fragment is generated and injures occupants;

Secondly, the tear lines of the airbag door are hidden for aesthetic appearance;

Thirdly, components of a steel hinge plate and a chute can be omitted, together with a laser scoring process, to decrease weight and cost; and

Fourthly, the airbag door is made of a ductile material undergoing little change as temperature varies, in contrast to the crash pad, so that the airbag can expand stably over a wide range of external temperatures and resist to impact from outside the door.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An airbag door structure for a vehicular passenger seat comprising:
a housing for containing an airbag in a cavity having an open top,
a crash pad coupled to an instrument panel, and
an airbag door coupled to the crash pad while covering the housing, wherein
the crash pad and the airbag door are integrally formed in a dual injection molding process using different materials.

2. The airbag door structure for a vehicular passenger seat as claimed in claim 1, wherein the crash pad comprises PPF.

3. The airbag door structure for a vehicular passenger seat as claimed in claim 1, wherein the airbag door is made of a material having higher ductility than the crash pad.

4. The airbag door structure for a vehicular passenger seat as claimed in claim 3, wherein the airbag door comprises TPO and/or TPE.

5. The airbag door structure for a vehicular passenger seat as claimed in claim 1, wherein the airbag door has tear lines formed on a lower surface thereof as V-grooves.

6. The airbag door structure for a vehicular passenger seat as claimed in claim 5, wherein the V-grooves of the airbag door are simultaneously formed in the dual injection molding process.

7. The airbag door structure for a vehicular passenger seat as claimed in claim 1, wherein a contact portion is formed in the shape of a step when the crash pad and the airbag door are injected.

8. An airbag door structure for a vehicular passenger seat comprising:
a housing for containing an airbag,
a crash pad coupled to an instrument panel, and
an airbag door coupled to the crash pad, wherein the crash pad and the airbag door are formed using different materials.

9. The structure of claim 8 wherein crash pad and the airbag door are formed by injection molding.

10. The structure of claim 8 wherein the crash pad and the airbag door are integrally formed in a dual injection molding process.

11. The structure of claim 8 wherein the crash pad comprises a phenolic polymer.

12. The structure of claim 8 wherein the airbag door is made of a material having higher ductility than the crash pad.

13. The structure of claim 11, wherein the airbag door comprises one or more thermoplastic olefins and/or one or more thermoplastic elastomers.

14. A vehicle comprising the airbag door structure of claim 1.

15. A vehicle comprising the airbag structure of claim 8.
